(19) United States
(12) Patent Application Publication
(10) Pub. No.: US 2024/0424647 A1
(43) Pub. Date: Dec. 26, 2024

(54) HAND-HELD PULLING AND COMPRESSION DEVICE AND MODULAR SYSTEM

(71) Applicant: TKR Spezialwerkzeuge GmbH, Gevelsberg (DE)

(72) Inventor: Torsten KREISCHER, Wetter (DE)

(21) Appl. No.: 18/752,716

(22) Filed: Jun. 24, 2024

(30) Foreign Application Priority Data
Jun. 26, 2023 (DE) 10 2023 116 744.8

(51) Int. Cl. B25B 21/00

(52) U.S. Cl. CPC B25B 21/00

(57) ABSTRACT

The invention relates to a hand-held pulling and compression device for driving interchangeable tools. In order to provide a hand-held pulling and compression device which can be used simply and flexibly for different work operations, it is provided that the pulling and compression device has a tool unit with a screw drive and a tool holder. The screw drive has a threaded spindle mounted rotatably on a housing body and a threaded nut mounted rotatably on the threaded spindle and non-rotatably on the housing body via a bearing unit. In addition, the pulling and compression device has a drive unit with a battery-operated electric motor for driving the threaded spindle, which drive unit can be connected to the tool unit via a coupling.

The invention relates to a hand-held pulling and compression device for driving interchangeable tools.

Hand-held pulling and compression devices, i.e. devices that can be used by a person on a mobile basis, such as hand-held, electric riveting and pressing devices for setting blind rivet elements, such as blind rivets and blind rivet nuts, or for carrying out punching processes and for setting punch rivets, which have a drive unit with an electric motor-driven threaded spindle of a screw drive, are known from the prior art in a variety of embodiments. The screw drive converts a rotational movement of the electric motor into a linear movement of the pulling and pressing tool in a known manner. In the case of the setting process of a blind rivet element, for example, a mandrel of the blind rivet element is moved axially.

The hand-held pulling and compression devices described above are used, for example, in vehicle workshops when carrying out repair work on the bodywork of vehicles and for maintenance work on tube or cable connections. Depending on the work to be carried out, it is necessary to use a large number of different interchangeable tools, for example with different forces, with the pulling and compression devices.

Known hand-held devices that enable the operation of both pulling and pressing tools have the disadvantage that their application possibilities are limited by the design of the device, in particular the screw drive and/or the drive unit.

On this basis, the invention is based on the object of providing a hand-held pulling and compression device which can be used simply and flexibly for different work operations.

The invention solves the object by a hand-held pulling and compression device with the features of claim 1 and by a modular system with the features of claim 8. Advantageous further embodiments of the hand-held pulling and compression device are given in claims 2 to 7.

The hand-held pulling and compression device according to the invention has a tool unit with a screw drive and a tool holder. The screw drive has a threaded spindle mounted rotatably on a housing body and a threaded nut mounted rotatably on the threaded spindle and non-rotatably on the housing body via a bearing unit. According to the invention, the pulling and compression device has a drive unit which can be connected to the tool unit via a coupling and has a battery-operated electric motor for driving the threaded spindle.

The tool unit is connected via a coupling unit to a tool holder, which is designed to interchangeably hold different tools required for the respective application, for example pulling and pressing tools and/or rotation tools. For example, when used as a compression device, the tool holder can be designed to hold a riveter, which is used in conjunction with a rivet clamp arranged on the compression device to set rivets. When used as a pulling device, the tool holder can, for example, be provided with suitable clamping devices for a shank of the blind rivet or have other means for transmitting tensile forces. Alternatively or additionally, the tool holder can also be designed to hold corresponding pulling tools, whereby the pulling tools have, for example, clamping means by means of which the tensile forces can then be transmitted.

The coupling unit is connected to the threaded nut in such a way that both tensile and compressive forces resulting from the direction of movement of the threaded spindle and the resulting linear adjustment of the threaded nut are reliably transmitted to the coupling unit.

The electric motor and the rechargeable battery for operating the electric motor are preferably arranged in a base body that can be connected to the housing body of the tool unit via the coupling. The coupling is preferably designed in such a way that the torque generated by the drive unit is transmitted to the screw drive when the drive unit is fixed to the tool unit.

The pulling and compression device according to the invention makes it possible to connect differently designed tool units to the drive unit depending on the work to be carried out, for example in the context of its use in a vehicle workshop when carrying out bodywork. The coupling provided according to the invention allows a simple and standardized connection of the various tool units optimized for the different work to the drive unit as well as a simple and quick replacement of the tool unit and/or the drive unit in the event of maintenance. The pulling and compression device formed by connecting the drive unit to a tool unit allows both pulling and pressing work to be carried out, for example setting blind rivets or carrying out punching work. The linear adjustment of the selected tool required for the respective work operation is reliably transmitted to the tool holder via the coupling unit, as the coupling unit transmits both tensile and compressive forces from the threaded nut to the respective tool via the tool holder.

According to an advantageous further development of the invention, it is provided that the coupling has a data link and a power supply. The data link enables the transmission of data between the drive unit and the tool unit. For example, measured values acquired by the tool unit are transmitted to the drive unit as data or information for various work operations, such as travel paths of the screw drive or the tool holder, is transmitted from the drive unit to the tool unit. The power supply also ensures that the tool unit is supplied with power by the drive unit. For example, the power supply enables a tool with a magnetic lock to be arranged on the tool unit and operated with it.

In principle, the tool unit can be fixed to the base body of the drive unit in any way. For example, a connection section arranged on the housing body of the tool unit is conceivable here, which is designed, for example, as a thread, which makes it possible to fix the tool unit with corresponding threads to a connecting section of the base body of the drive unit. According to an advantageous embodiment of the invention, it is provided that the coupling for connecting the drive unit to the tool unit is designed as an electrical and/or mechanical coupling. For example, the coupling is designed as a mechanical bayonet lock or as a ball lock. Irrespective of its design as an electrical or mechanical coupling, the coupling can preferably be adjusted between a locked position and an unlocked position. In the locked position, the tool unit and the drive unit are preferably connected to each other in such a way that the torque generated by the drive unit is transmitted to the tool unit, for example the threaded spindle of the screw drive. In the unlocked position, the tool unit and the drive unit can be separated from each other so that the tool unit or the drive unit can be replaced easily and flexibly if necessary.

Preferably, the coupling is designed as a quick coupling. The use of a quick coupling, which is characterized by the fact that it can be quickly adjusted by the operator with little effort between the unlocked position, in which the tool unit can be arranged on or removed from the drive unit, and the locked position, in which the tool unit is fixed to the drive unit. The quick coupling is characterized in particular by the fact that additional tools for removing or arranging the tool unit can be dispensed with. A design of the hand-held pulling and compression device with a quick coupling thus enables a quick and convenient change or mounting and demounting of a tool unit on or from the pulling and compression device.

In principle, the quick coupling can be adjusted between the unlocked and locked positions in any way, e.g. the quick coupling can be designed in such a way that it can be mechanically adjusted between the unlocked and locked positions by an operator. It is particularly preferable for the quick coupling to be adjustable between the unlocked and locked positions by means of the drive unit. The use of the drive unit to operate the quick coupling, i.e. to adjust it between the unlocked and locked positions, increases the convenience of the hand-held pulling and compression device in a special way. Incorrect operation of the quick couplings is also minimized or completely avoided by operation using the drive unit.

According to an advantageous further development of the invention, it is provided that the tool unit has a switching unit which can be adjusted between a coupling state connecting the threaded spindle to the drive unit, in particular with the coupling arranged in the locked position, and a decoupling state separating the threaded spindle from the drive unit. In the coupling state, the screw drive is preferably connected to the drive unit via the switching unit in such a way that rotational movements of the electric motor are transmitted to the threaded spindle. In the decoupling state, the screw drive is preferably separated from the drive unit by the switching unit in such a way that the rotational movement of the electric motor is not transmitted to the threaded spindle.

The switching unit is adjusted between the positions manually, for example by a user, or automatically, for example by a control unit. The switching unit also allows the screw drive to be decoupled from the drive unit in a simple manner even when the coupling is in the locked position, as a result of which the rotational movement of the electric motor is not transmitted to the threaded spindle and the linear adjustment of the threaded nut and/or the coupling unit and/or the tool holder is thus blocked.

According to an advantageous embodiment of the invention, it is provided that the threaded spindle and/or the switching unit and/or the rotating shaft is designed for positive connection to a drive shaft of the drive unit. Preferably, the rotating shaft and the switching unit have at least one coupling section for positive connection to the drive shaft. The threaded spindle can preferably be connected to the drive shaft indirectly via the switching unit.

The rotating shaft preferably has at least one first coupling section, which is particularly preferably engageable with a coupling portion arranged on the drive shaft.

The first coupling section and/or the coupling portion are preferably designed such that in the locked position a positive fit between the rotating shaft and the drive unit in the circumferential direction of the longitudinal axis of the drive shaft is created. Preferably, the switching unit is positively connected to the drive shaft of the drive unit, for example via a second coupling section designed as a feather key or a connection similar to a feather key.

The coupling portion is preferably arranged on an end portion of the drive shaft. The end portion of the drive shaft describes a section extending from an end surface of the drive shaft in the direction of the longitudinal axis of the drive shaft. Preferably, the first coupling section is formed as a projection projecting from an end surface of the rotating shaft facing the drive unit and the coupling portion is formed as a recess in the end surface of the drive shaft.

The coupling sections advantageously provided on the rotating shaft and/or the switching unit as well as the coupling portion preferably provided on the drive shaft enable the rotating shaft and/or the switching unit and/or the screw drive to be fixed to the drive unit in a simple manner and, due to the positive locking in the circumferential direction of the drive shaft, a particularly reliable transmission of the rotational movement of the drive unit to the tool unit.

Preferably, the screw drive of the tool unit is designed in such a way that a rotating shaft for transmitting rotational movements of the electric motor to a tool can be arranged on the electric motor. According to an advantageous further development of the invention, it is provided that the threaded spindle is designed as a hollow spindle for receiving a rotating shaft that can be connected to the drive unit. A hollow spindle is understood to be a threaded spindle with a hollow space extending in the longitudinal axis direction of the threaded spindle. The rotating shaft can preferably be connected to the electric motor in such a way that the rotating shaft can be rotated independently of the switching unit arranged in the coupling state or in the decoupling state. Preferably, the rotating shaft is arranged coaxially to the hollow spindle. Particularly preferably, the rotating shaft is mounted in the hollow spindle so that it can rotate about the longitudinal axis of the hollow spindle. For example, at least one bearing element, e.g. a rolling bearing, such as a needle roller and cage assembly or a ball bearing, is provided for mounting the rotating shaft. Particularly preferably, the tool holder is also hollow in order to enable a rotating tool to be connected to the rotating shaft without prior demounting of the tool holder connected to the coupling unit.

The design of the threaded spindle as a hollow spindle makes it easy to arrange the rotating shaft on the drive unit so that the rotating shaft can be rotated independently of the position of the switching unit. This makes it easy to switch between the transmission of tensile and/or compressive forces via the tool holder and the transmission of rotational movements via the rotating shaft. Furthermore, there is no need for a further tool holder connected to the threaded spindle for replacement of the tool holder connected to the coupling unit. In addition, the rotational movement transmitted from the rotating shaft to a tool is not restricted by the stroke of the threaded nut and/or the tool holder, so that the hand-held pulling and compression device is particularly flexible in use.

In principle, the torque of the drive unit can be transmitted to the tool unit, in particular the switching unit and/or the threaded spindle and/or the rotating shaft, in any desired manner. It is preferable for the drive unit to have a gear connected to the electric motor, which has the drive shaft that can be connected to the tool unit. The use of a gear allows high torques to be transmitted in a small installation space and weight.

The gears used are, for example, two- to three-stage planetary gears, but also cycloidal and spur gears, which offer the desired transmissions. The speed of the electric motor is preferably 25000-30000 rpm, preferably 26000-29000 rpm, particularly preferably 27000-28000 rpm, most preferably 27500 rpm. In combination with preferably provided brushless motors, which are battery-operated, an optimal coordination between gear, threaded spindle and the resulting force can be achieved. Furthermore, the drive unit, in particular the electric motor and/or the gear, are formed in such a way that a torque of 10-100 Nm, preferably 15-95 Nm, most preferably 15-25 Nm and/or 75-95 Nm can be transmitted to the tool unit, in particular the threaded spindle and/or the rotating shaft.

In the simplest embodiment of the drive unit, the electric motor can be operated in such a way that only the direction of rotation of the drive shaft can be selected. Particularly preferably, the drive unit has a control unit connected to at least one sensor unit for controlling and/or archiving the operating processes.

The use of a control unit allows targeted control of the corresponding operating processes, for example pulling, pressing and/or turning operations as well as, for example, adjusting the coupling between the unlocked position and the locked position. For example, the control unit can be used to set the intended tensile or compressive forces in a particularly simple manner so that the operating processes can be carried out particularly reliably. Preferably, the control unit can be used to automatically adjust the switching unit and the coupling, in particular the quick coupling. On the one hand, this enables particularly simple and flexible mounting and demounting of the tool unit from the drive unit and, on the other hand, the programming of more complex operations in which different work operations, for example using tensile and compressive forces or torques, can be carried out one after the other or in any combination. For example, a blind rivet nut is first screwed into the thread provided for this purpose by the torque transmitted via the rotating shaft and then, after switching the switching unit from the decoupling state to the coupling state, is set by the tensile forces generated by the screw drive and transmitted to the tool holder via the coupling unit. The control unit can also be provided to archive the operating processes carried out so that the work carried out can be reliably logged.

The sensor unit can be designed to monitor the adjustment travel, the pulling and pressing forces, the torque or the like, which is required for carrying out the work processes and their successful completion. Furthermore, the sensor unit can, for example, monitor the coupling and display a warning or error message on a preferably provided display in the event of a faulty connection between the tool unit and the drive unit. The display also makes it particularly easy for the operating personnel to operate the hand-held pulling and compression device. Furthermore, the hand-held pulling and compression device can also be connected to a central database or a mobile hand-held device, for example a smartphone or a tablet, via suitable wireless transmission means.

The invention further solves the object by means of a modular system for a hand-held pulling and compression device according to the invention or further developed as described above, with at least two tool units designed to generate different tensile and compressive forces and at least one drive unit which can be connected to the tool units in each case.

The tool units preferably differ in their design, which is optimized for certain work operations, in particular with regard to the weight, dimensions or ergonomics of the tool unit. For example, the threaded spindles of the tool units have different pitches or the tool units are connected in one piece with different tools, making it impossible to change the tools.

The system according to the invention makes it possible to use the hand-held pulling and compression device for a variety of different work operations and to operate different tool units with one drive unit. This provides a continuously expandable system for the hand-held pulling and compression device, in which the drive unit is used sustainably and yet different working fields are given.

An embodiment of the invention is explained below with reference to the drawings. The drawings show in:

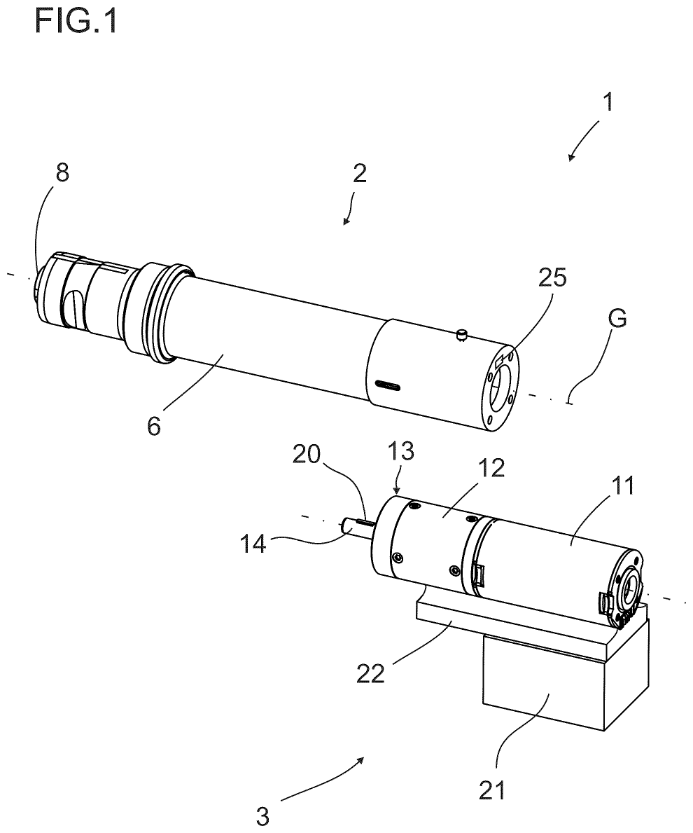

FIG. 1 a perspective view of a schematic representation of a pulling and compression device with a tool unit and a drive unit separated from the tool unit;

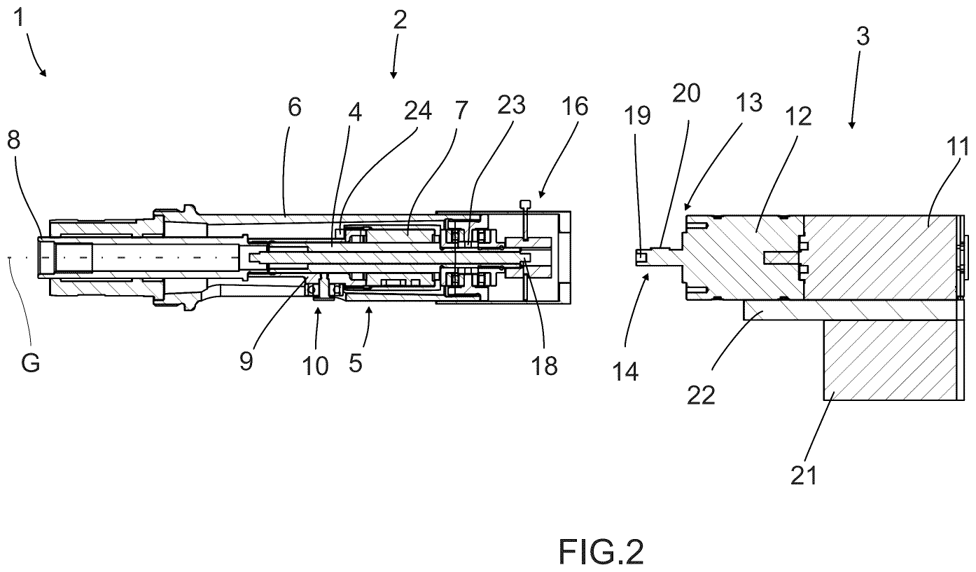

FIG. 2 in a sectional view, a schematic representation of the pulling and compression device of FIG. 1 and

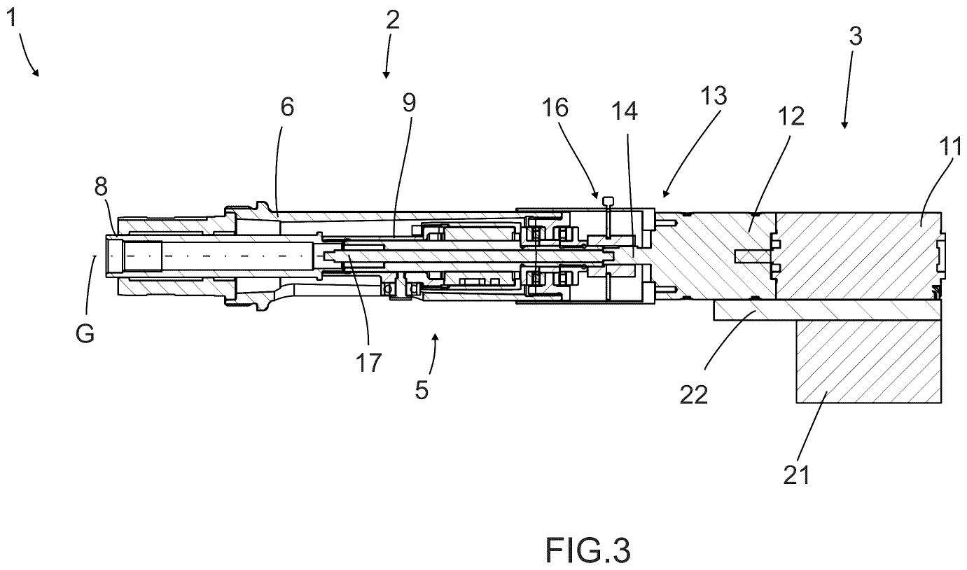

FIG. 3 in a sectional view, a schematic representation of the pulling and compression device of FIGS. 1 and 2 with the tool unit and the drive unit connected to the tool unit via a coupling.

FIG. 1 shows a perspective view of a pulling and compression device 1 with a tool unit 2 and a drive unit 3 separated from the tool unit 2.

The tool unit 2 has a threaded spindle 4 of a thread drive 5, which threaded spindle is connectable to the drive unit 3 and rotatably mounted on a housing body 6 of the tool unit 2 (see FIG. 2).

In addition to the threaded spindle 4, the screw drive 5 has a threaded nut 7 arranged on the threaded spindle 4, which is mounted non-rotatably on the housing body 6. The threaded nut 7 is used to drive a tool holder designed as a piston rod 8, which is mounted so as to be adjustable in the longitudinal axis direction of the threaded spindle 4, i.e. in the direction of the threaded spindle axis G. The piston rod 8 is connected to the threaded nut 7 via a detachable coupling unit 9. A bearing unit 10, which is attached to the coupling unit 9, is used for non-rotatable mounting of the threaded nut 7 on the housing body 6.

The drive unit 3 has an electric motor 11 and a gear 12 comprising a drive shaft 14 and connected to the electric motor 11. The drive unit 3 can be connected to the tool unit 2 via a coupling 13. The coupling 13 can be adjusted between an unlocked position shown in FIGS. 1 and 2 and a locked position shown in FIG. 3. Furthermore, the coupling has a data link for transmitting signals between the tool unit 2 and a control unit 22 of the drive unit 3 as well as a power supply for the tool unit 2.

The tool unit 2 also has a switching unit 16 for coupling and decoupling the screw drive from the drive unit 3. The switching unit 13 can be adjusted between a coupling state connecting the threaded spindle 4 to the drive unit 3, shown as an example in FIG. 3, and a decoupling state separating the threaded spindle 4 from the drive unit 3.

In this design example, the threaded spindle is designed as a hollow spindle 4 to accommodate a rotating shaft 17 connected to the electric motor 3. The rotating shaft 17 can be connected to the drive unit 3 in such a way that the rotating shaft 17 can be rotated independently of the switching unit 16 arranged in the coupling state or in the decoupling state. Furthermore, the rotating shaft 17 is arranged coaxially to the hollow spindle 6.

The rotating shaft 17 has a first coupling section 18 that can be brought into engagement with a coupling portion 19 arranged on the drive shaft 14. The first coupling section 18 and the coupling portion 19 are designed in such a way that, in the locked position of the coupling, a positive fit is generated between the rotating shaft 17 and the drive unit 3 in the circumferential direction of the longitudinal axis of the threaded spindle axis G. Furthermore, the switching unit 16 is positively connected to the drive shaft 14 of the drive unit 3 via a second coupling section 20 designed as a feather key (see FIG. 3).

Furthermore, the drive unit 3 has a rechargeable battery 21 for operating the electric motor 11 and the control unit 22 for controlling and/or archiving the operating processes. The control unit 22 is connected to a rotation sensor 23 for detecting the torque of the drive unit 3 and a force sensor 24 for detecting the tensile and compressive forces of the tool unit 2. Furthermore, the control unit 22 is connected to a contact sensor 25 for inspecting the connection of the tool unit 2 to the drive unit 3 via the coupling 13. The electric motor 11, the rechargeable battery 21 and the control unit 22 are arranged in a base body, not shown, which can be connected to the housing body 6 of the tool unit 2 via the coupling 13.

A system, not shown, for the hand-held pulling and compression device 1 has at least two tool units 2 designed to generate different tensile and compressive forces and at least one drive unit 3 which can be connected to the tool units 2 in each case.

All of the features explained in connection with individual embodiments of the invention can be provided in different combinations for the hand-held pulling and compression device or the modular system in order to realize their advantageous effects, even if they have been described for different embodiments. For example, the coupling 13 for connecting the drive unit 3 to the tool unit 2 is designed as an electrical quick coupling, which can be electrically adjusted between the locked position and the unlocked position via the control unit 22.

### LIST OF REFERENCE SYMBOLS

1 Pulling and compression device
2 Tool unit
3 Drive unit
4 Threaded spindle (hollow spindle)
5 Screw drive
6 Housing body
7 Thread nut
8 Tool holder (piston rod)
9 Coupling unit
10 Bearing unit
11 Electric motor
12 Transmission
13 Coupling
14 Drive shaft
16 Switching unit
17 Rotating shaft
18 First coupling section
19 Coupling portion
20 Second coupling section (feather key)
21 Rechargeable battery
22 Control unit
23 Rotation sensor
24 Force sensor
25 Contact sensor
G Threaded spindle axis

1. Hand-held pulling and compression device for driving pulling and pressing tools, with
a tool unit, comprising
a screw drive with a threaded spindle mounted rotatably on a housing body and a threaded nut mounted rotatably on the threaded spindle and non-rotatably on the housing body via a bearing unit, and
a coupling unit connected to a tool holder for transmitting tensile and compressive forces resulting from the direction of rotation of the threaded spindle from the threaded nut to the tool holder, and
a drive unit, which can be connected to the tool unit via a coupling, with a battery-operated electric motor for driving the threaded spindle.

2. Hand-held pulling and compression device according to claim 1, wherein the coupling has a data link and a power supply.

3. Hand-held pulling and compression device according to claim 1, wherein the coupling for connecting the drive unit to the tool unit is designed as an electrical and/or mechanical coupling.

4. Hand-held pulling and compression device according to claim 1, wherein the coupling is designed as a quick coupling.

5. Hand-held pulling and compression device according to claim 1, wherein the tool unit has a switching unit which can be adjusted between a coupling state connecting the threaded spindle to the drive unit and a decoupling state separating the threaded spindle from the drive unit.

6. Hand-held pulling and compression device according to claim 1, wherein the threaded spindle and/or the switching unit is designed for positive connection to a drive shaft of the drive unit.

7. Hand-held pulling and compression device according to claim 1, wherein the threaded spindle is designed as a hollow spindle for receiving a rotating shaft which can be connected to the drive unit.

8. Modular system for a hand-held pulling and compression device according to claim 1, comprising
at least two tool units designed to generate different tensile and compressive forces, and
at least one drive unit that can be connected to each of the tool units.

9. Hand-held pulling and compression device according to claim 2, wherein the coupling for connecting the drive unit to the tool unit is designed as an electrical and/or mechanical coupling.

10. Hand-held pulling and compression device according to claim 2, wherein the coupling is designed as a quick coupling.

11. Hand-held pulling and compression device according to claim 3, wherein the coupling is designed as a quick coupling.

12. Hand-held pulling and compression device according to claim 2, wherein the tool unit has a switching unit which can be adjusted between a coupling state connecting the threaded spindle to the drive unit and a decoupling state separating the threaded spindle from the drive unit.

13. Hand-held pulling and compression device according to claim 3, wherein the tool unit has a switching unit which can be adjusted between a coupling state connecting the threaded spindle to the drive unit and a decoupling state separating the threaded spindle from the drive unit.

14. Hand-held pulling and compression device according to claim 4, wherein the tool unit has a switching unit which can be adjusted between a coupling state connecting the threaded spindle to the drive unit and a decoupling state separating the threaded spindle from the drive unit.

15. Hand-held pulling and compression device according to claim 2, wherein the threaded spindle and/or the switching unit is designed for positive connection to a drive shaft of the drive unit.

16. Hand-held pulling and compression device according to claim 3, wherein the threaded spindle and/or the switching unit is designed for positive connection to a drive shaft of the drive unit.

17. Hand-held pulling and compression device according to claim 4, wherein the threaded spindle and/or the switching unit is designed for positive connection to a drive shaft of the drive unit.

18. Hand-held pulling and compression device according to claim 2, wherein the threaded spindle is designed as a hollow spindle for receiving a rotating shaft which can be connected to the drive unit.

19. Hand-held pulling and compression device according to claim 3, wherein the threaded spindle is designed as a hollow spindle for receiving a rotating shaft which can be connected to the drive unit.

20. Hand-held pulling and compression device according to claim 3, wherein the threaded spindle is designed as a hollow spindle for receiving a rotating shaft which can be connected to the drive unit.
